(19) United States
(12) Patent Application Publication
(10) Pub. No.: US 2021/0399273 A1
(43) Pub. Date: Dec. 23, 2021

(54) ELECTRICALLY CONDUCTIVE RETICULATED ELECTRODE STRUCTURE AND METHOD THEREFOR

(71) Applicant: Jonathan Jan, Culver CIty, CA (US)

(72) Inventor: Jonathan Jan, Culver CIty, CA (US)

(21) Appl. No.: 16/904,008

(22) Filed: Jun. 17, 2020

(51) Int. Cl. H01M 4/04; H01M 4/78

(52) U.S. Cl. CPC H01M 4/0402; H01M 2004/028; H01M 4/78

(57) ABSTRACT

A method of forming an electrode in an electrochemical battery comprises coating a reticulated substrate with a first wash, the first wash having a conductive material with conductive fibrous members and curing the reticulated substrate coated with the first wash having the conductive material with the conductive fibrous members.

### RELATED APPLICATIONS

The present patent application is related to U.S. Pat. No. 10,079,382, issued on Sep. 18, 2018, entitled “Reticulated Electrode Structure and Method of Making the Same” and U.S. patent application having Ser. No. 16/103,075, filed Aug. 14, 2018, entitled “Reticulated Electrode Structure and Method of Making the Same” both in the name of the same inventors as the present application and both of which are incorporated by reference in its entirety into the present patent application.

### TECHNICAL FIELD

The present application generally relates to a battery, and more specifically, to a method of forming an electrically conductive reticulated electrode structure for an electrochemical battery that increases the reacting surface area thereby increasing the capacity and efficiency of the electrochemical battery, while reducing the weight and unusable metals of the battery.

### BACKGROUND

Electrochemical batteries generally include pairs of oppositely charged plates (positive and negative), and an intervening electrolyte to convey ions from one plate to the other when the circuit through the battery is completed. The ability of the electrochemical battery to deliver electrical current is generally a straight-line function of the surface area of the plates which is contacted by the electrolyte. A flat plate constitutes a lower limit, which is frequently improved by sculpting the surface of the plate. For example, waffle shapes are known to have been used. However, there is a physical limitation to what can be done to “open-up” the surface of the plates, because the plates must resist substantial mechanical stringencies such as vibration and acceleration, and must be strongly supported at their edges. Thus, plates which are rendered delicate by casting or molding them into shapes which have thin sections are not a viable solution to increase the surface area of the plates. Further, such plates are subject to erosion and loss of material, thereby further reducing the strength of the plate over the life of the battery. A tempting solution is to use a woven screen for a plate. However, screens can be bent, usually on two axes. Especially after significant erosion they do not have sufficient structural strength. A battery is destroyed if a screen or plate collapses or contacts a neighboring screen/plate.

Despite the inherent potential structural disadvantages, it is a valid objective to attempt to increase the area exposed to the electrolyte by giving access to interior regions of a plate in order to increase the capacity and efficiency of the electrochemical battery, Otherwise the entire interior of the plate serves as no more than an electrical conductor and support for the surface of the plate. Holes through the plate can in fact increase surface area by the difference between their area removed from the surface and the added area of their walls. However, there is an obvious limitation to this approach.

A benefit in addition to increased surface area which could be obtained with an open-structured plate is the storage of electrolyte within the envelope of the plate. In turn, for a given amount of electrolyte volume, the gross volume of the battery can be reduced by the amount which is stored in the plates, rather than in the spacing between plates. Evidently the problem is one of increasing the surface area of the plates without compromising their strength.

Snaper, in U.S. Pat. No. 6,060,198 describes reticulated metal structures as plates for used as electrodes in the electrochemical battery. The reticulated structure consists of a plurality of pentagonally faced dodecahedrons. The reticulated metal structure is able to increase the capacity and efficiency of electrochemical batteries, while reducing the weight and unusable metals of the battery. However, the cost of making such metal forms may be cost prohibitive for commercial production. Further, depositing metals on the reticulated polymer substrate is difficult. Vacuum plating, plasma deposition and other methods may only deposit thick coats of metal on the bearing surface. Thus, the metal may not be able to penetrate deep into the core of the substrate, thereby limiting the reacting surface area within the core of the substrate.

Snapper, U.S. Pat. No. 10,079,382 discloses a method of forming a reticulated plate for an electrode in an electrochemical battery. The method coats a reticulated substrate with a conductive material. The reticulated substrate coated with the conductive material is then cured. Next, one may electroplate the reticulated substrate coated with the conductive material with a desired metal material. While the above method may significantly improve the surface area and additional electrolyte capacity, further increasing the surface area is desirable.

Secondary chemical batteries usually have a metal negative electrode and a metal-oxide positive electrode. Electrical conductivity has always been an obstacle for the metal-oxide electrode, which is non-conductive. The metal-oxide performs ionic exchange with the electrolyte to cause electron flow, but the high resistivity inhibits the electrons from flowing into the battery to complete the chemical reactions. To overcome this hurdle, carbon or metal powders are mixed with the metal-oxide to make it conductive.

In a lead-acid battery, the positive electrode is fabricated by mixing lead powder and lead-oxide powder with cement. The mixture is pressed onto a lead current collector grid and oven-cured. Then it takes a tedious and lengthy process to remove the cement material by repeated acid washes. This causes serious environmental hazards. The resultant electrode lacks integrity and mechanical strength. The high internal resistivity produces heat during the charging-discharging cycles, leading to disintegration and precipitation in the electrolyte. This leads to electrical short that is primary cause of battery failures. In the case of an alkaline battery, the positive electrode is made by mixing manganese oxide with carbon powder and press-formed. Again, the problems of high internal resistivity and mechanical weakness are still intrinsic to the electrode architecture.

Therefore, it would be desirable to provide a system and method that overcomes the above.

### SUMMARY

In accordance with one embodiment, a method of forming an electrode in an electrochemical battery is disclosed. The method comprises: coating a reticulated substrate with a first wash, the first wash having a conductive material with conductive fibrous members and curing the reticulated substrate coated with the first wash having the conductive material with the conductive fibrous members.

In accordance with one embodiment, a method of forming an electrode in an electrochemical battery is disclosed. The method comprises: coating a reticulated ceramic substrate with a first wash, the first wash having a conductive material with conductive fibrous members; curing the reticulated ceramic substrate coated with the first wash; applying a second wash to the reticulated ceramic substrate, the second wash comprising the first wash and battery cathode materials; curing the reticulated ceramic substrate coated with the second wash; and covering the reticulated ceramic substrate with a molecular sieve.

In accordance with one embodiment, a method of forming an electrode in an electrochemical battery is disclosed. The method comprises: applying an adhesive and molecular sieve material mixture to a reticulated open-cell polymer foam; curing the reticulated open-cell polymer foam having the adhesive and molecular sieve material mixture; applying a silica sand to the molecular sieve material; and applying an electrode metal to the reticulated open-cell polymer foam.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is a cross-sectional front view of an electrode made in accordance with an embodiment of the present invention;

FIG. 2 is a front view of an electrode made partially coated in accordance with an embodiment of the present invention;

FIG. 3 is a first magnified view of an electrode made in accordance with an embodiment of the present invention;

FIG. 4 is a further magnified view of the electrode of FIG. 2, made in accordance with an embodiment of the present invention; and

FIG. 5 is a further magnified view of the electrode of FIG. 2, made in accordance with an embodiment of the present invention;

FIG. 6 is a flowchart showing a method of forming the electrode, in accordance with an embodiment of the present invention; and

FIG. 7 is a flowchart showing a method of forming the electrode, in accordance with an embodiment of the present invention.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

Embodiments of the exemplary system and method disclose a reticulated electrode structure for use in an electrochemical battery. The reticulated electrode structure may be formed using a methodology that may increase the reacting surface space. By increasing the surface space of the reticulated electrode structure, one may increase the capacity and efficiency of the electrochemical battery. By increasing the surface space of the reticulated electrode structure, one may reduce the weight and unusable metals of the electrochemical battery.

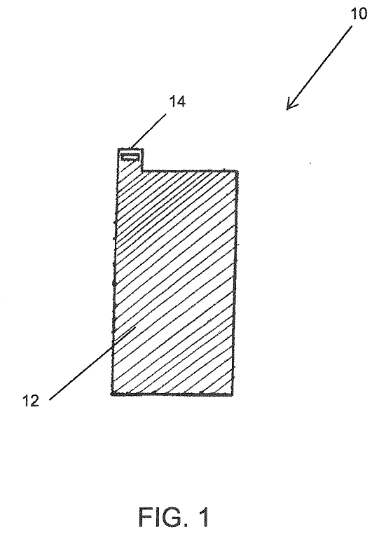

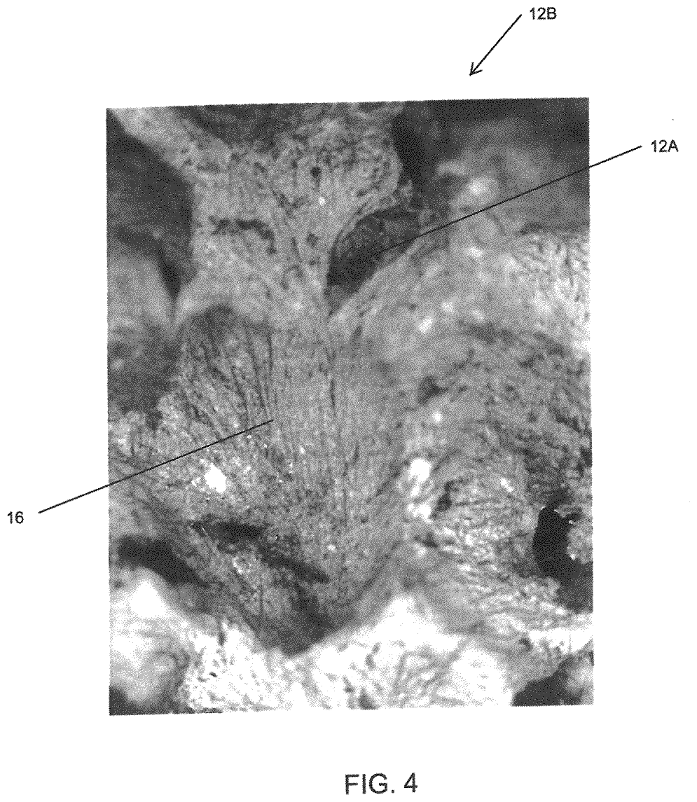

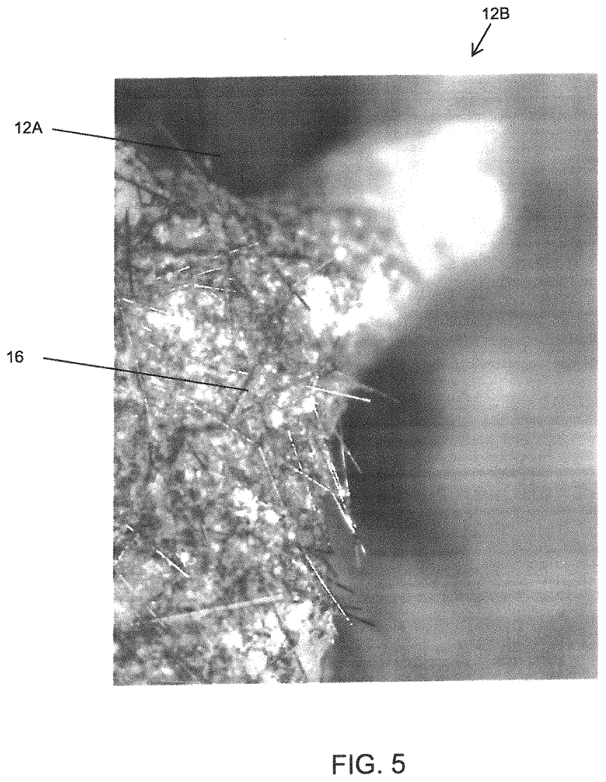

Referring to FIGS. 1-5, an electrode structure 10 according to one embodiment of the present invention may be seen. The electrode structure 10 may be used as one or more positive plates and/or one or more negative plates in an electrochemical battery. The electrode structure 10 may be formed of a non-conductive reticulated substrate 12. The non-conductive reticulated substrate 12 may have a plurality of interconnecting channels 12A. The inter interconnecting channels 12A may allow an aqueous solution to flow through the non-conductive reticulated substrate 12.

In accordance with one embodiment, the non-conductive reticulated substrate 12 may be reticulated polymer foam. For example, polyurethane foam or similar foam may be used. The reticulated polymer foams may be open celled. Open cell reticulated polymer foam may have air pockets or tubes formed therein that are connected together. The air pockets or tubes coupled together allow a liquid substance to flow through the entire structure, displacing the air. Thus, the air pockets/tubes may increase the usable surface area for chemical reaction. Open cell reticulated polymer foams are generally light weight and flexibility. This may allow the electrode structure 10 to be lightweight and formed in a variety of shapes.

In accordance with one embodiment, the non-conductive reticulated substrate 12 may be formed of a reticulated ceramic material. Ceramic materials are generally inorganic, non-metallic materials from compounds of a metal and a non-metal. Ceramic materials may be crystalline or partly crystalline. The crystalline or partly crystalline structure form microscopic hollow interconnecting cells which may increase the usable surface area for chemical reaction. The rigidity and integrity of ceramic materials may allow the electrode structure 10 to be used in applications demanding high tensile strength of the electrode structure 10.

A connector 14 may be formed on the non-conductive reticulated substrate 12. The connector 14 may be used to couple the electrode structure 10 to a positive and/or negative connector of the electrochemical battery.

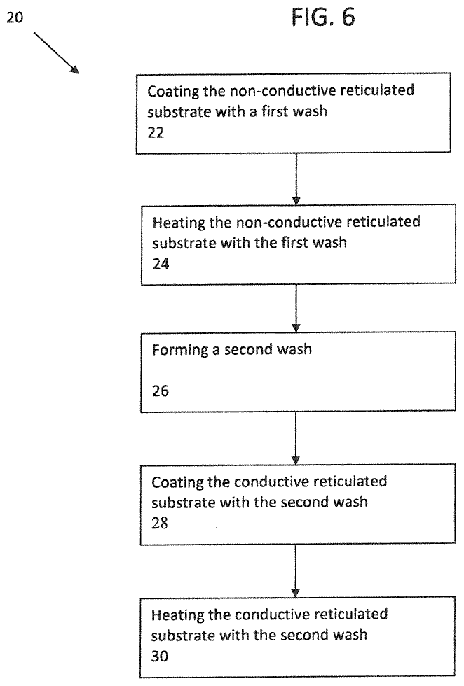

Referring to FIGS. 1-6, one embodiment of a method 20 of treating the non-conductive reticulated substrate 12 for forming the electrode structure 10 may be disclosed. The method 20 may allow the non-conductive reticulated substrate 12 to be coated with a conductive material 16.

In the method 20, the non-conductive reticulated substrate 12 may be coated with a first wash/coating (hereinafter first wash) as shown in 22. The first wash may be formed of carbon nanotubes (CNT), carbon fiber (CF) powder and graphite mixed with silica and an aqueous solution to form a water-based first wash. The aqueous solution may be ethanol, alcohol, water or similar aqueous solutions.

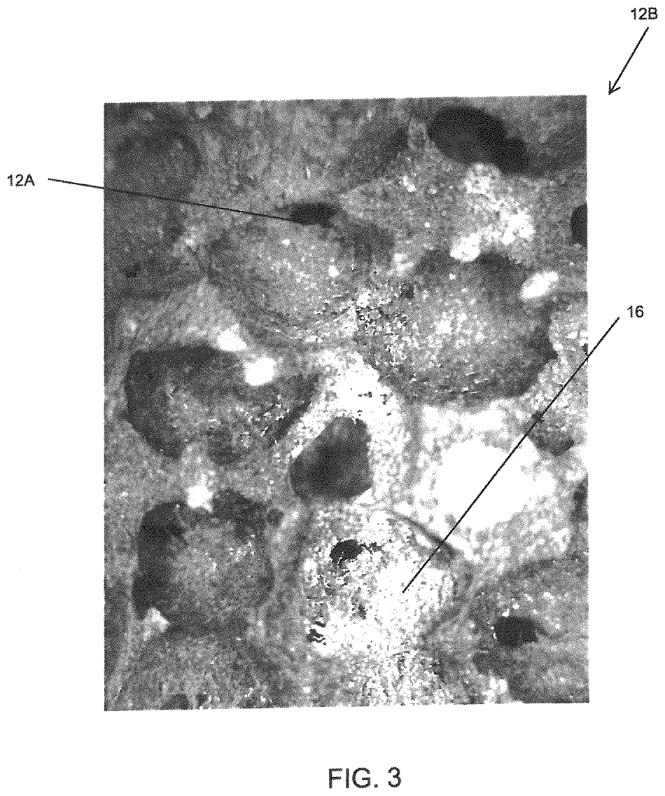

The liquidity of the first wash may allow the first wash to flow through the interconnecting channels 12A of the non-conductive reticulated substrate 12. In accordance with one embodiment, ultrasonic dispersion may be used when coating the non-conductive reticulated substrate 12 with a first wash. Ultrasonic devices may be used to aid in the dispersion of nanomaterials in order to break-up particle agglomerates. This may provide a more even distribution of the nanomaterials on the non-conductive reticulated substrate 12 and within the interconnecting channels 12A of the non-conductive reticulated substrate 12. This may be seen more clearly in FIGS. 3-5. In these figures, one can see the first wash coated on the surface of non-conductive reticulated substrate 12 and within the interconnecting channels 12A.

In accordance with one embodiment, molecular sieve materials may be added to the first wash. The molecular sieve material may be microporous material such as zeolites, active carbons or the like. These types of molecular sieve materials may have a porous structure that can accommodate a wide variety of cations, such as Na⁺, Ca²⁺, Mg²⁺ and others. These positive ions may have low bandgap and may be rather loosely held which can readily be exchanged for others in a contact solution. The addition of the microporous molecular sieve material such as zeolite may allow the surfaces of the non-conductive reticulated substrate 12 to not only be conductive, but also “porous”. Thus, by including the microporous molecular sieve material in the first wash, more surface area of the non-conductive reticulated substrate 12 may be available for reactions with the electrolytes. It should be noted that different molecular sieves may be used depending on the battery chemistry.

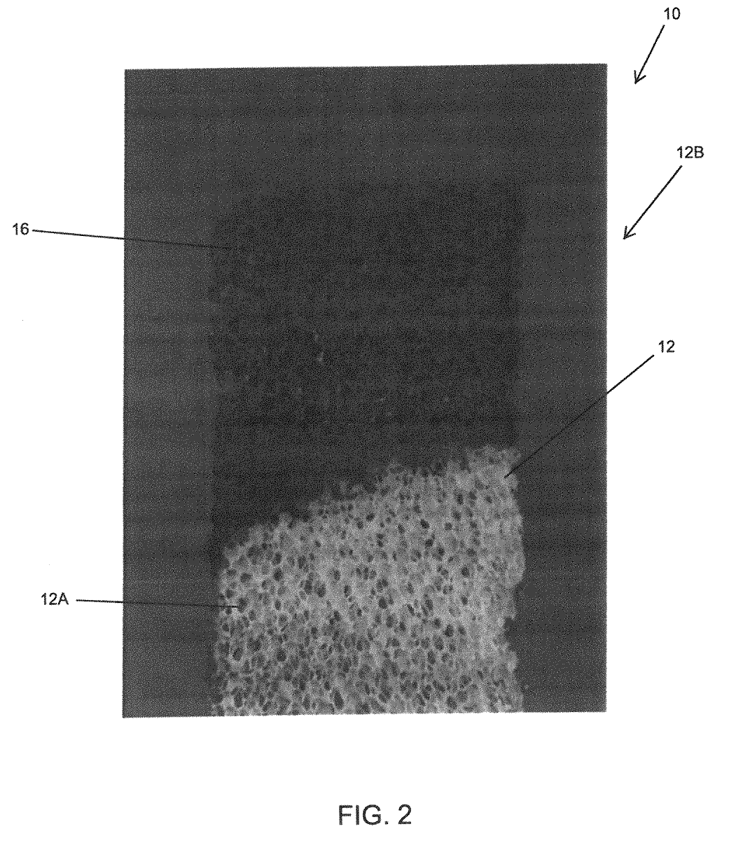

The non-conductive reticulated substrate 12 with the first wash may them be heated as shown in 24. In accordance with one embodiment, the non-conductive reticulated substrate 12 with the first wash may be cured in a kiln. The kiln may be placed at a temperature between 200° C.-500° C. The above is given as an example and should not be seen in a limiting manner. The heating of the non-conductive reticulated substrate 12 may allow the aqueous solution of the first wash to evaporate and/or burn off. The heating cycle may allow the epoxy coating on CF to gasify. The CF, CNT and Graphite may then form a conductive network by the principle of self-organization. The result is a porous conductive layer on the surface of the non-conductive reticulated substrate 12 and within the interconnecting channels 12A of the non-conductive reticulated substrate 12 forming a conductive reticulated substrate 12B as shown in FIG. 2. It should be noted that only a portion of the non-conductive reticulated substrate 12 was coated in FIG. 2. In general, all of the non-conductive reticulated substrate 12 would be coated. Due to the excellent conductivity of CNT, the electrode structure 10 may have a resistivity as low as 0.2 ohms. The CF and CNT may also serve as fiber-reinforcement. Tis may improve the mechanical strength of the electrode structure 10.

Battery cathode materials, for example, Manganese-oxide, Lead-oxide, Nickel-oxide and similar material may be blended with the first wash forming a second wash as shown in 26. Alternatively, catalysts such as Titanium dioxide and Cerium-dioxide may also be used to form the second wash. The conductive reticulated substrate 12B may be coated with the second wash as shown in 28. Additional aqueous solution may be added to the second wash to ensure the liquidity of the second wash. The liquidity of the second wash may allow the second wash to flow through the interconnecting channels 12A of the conductive reticulated substrate 12B. In accordance with one embodiment, ultrasonic dispersion may be used when coating the conductive reticulated substrate 12B with the second wash.

The conductive reticulated substrate 12B with the second wash may be heated as shown in 30. The heating may be done to cure materials of the second wash on the conductive reticulated substrate 12B. In accordance with one embodiment, the conductive reticulated substrate 12B with the second wash may be placed in a kiln for heating. The kiln may be set at temperature ranging from 450° C. to 850° C. to fuse the second wash to the conductive reticulated substrate 12B. Once cured, the conductive reticulated substrate 12B may be covered with molecular sieve (zeolite). The advantage of this architecture is large surface area for ionic exchange in a chemical battery cell. Batteries made with this type of electrode and solid-gel electrolytes may have high system integrity. Precipitation and internal electrical short may be mechanically inhibited.

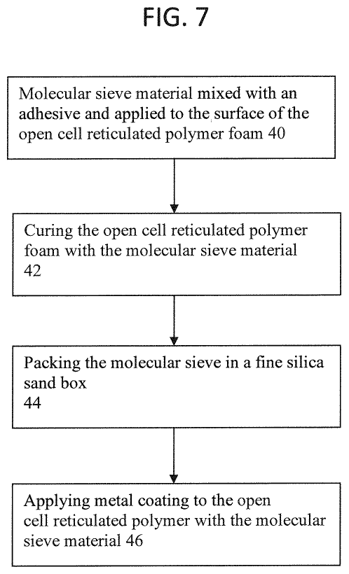

Referring to FIG. 7, in accordance with one embodiment, a molecular sieve material may be applied to the open cell reticulated polymer foam. Molecular sieves are crystalline metal aluminosilicates having a three-dimensional interconnecting network of silica and alumina tetrahedra or other materials. Natural water of hydration is removed from this network by heating to produce uniform cavities which selectively adsorb molecules of a specific size. The molecular sieve material may be used to increase a tensile strength of the open cell reticulated polymer foam and to increase the reaction surface area. The porosity of the molecular sieve material may allow is also advantageous for battery electrolyte reactions.

In accordance with one embodiment, the molecular sieve material may be applied to the open cell reticulated polymer foam as shown in 40. The molecular sieve material may be applied in different manners. For example, the open cell reticulated polymer foam may be brushed with or dipped in a mixture of molecular sieve material and carbon based conductive adhesive paste. In accordance with one embodiment, the molecular sieve material may be zeolite or other similar molecular sieve materials. After the mixture of the adhesive and molecular sieve material is applied, the open cell reticulated polymer foam with the molecular sieve material is cured as shown in 42. Curing may allow the sieve material to harden thereby increasing the tensile strength of the open cell reticulated polymer foam. The open cell reticulated polymer foam maybe air cured or inserted into an oven for curing.

After curing, the open cell reticulated polymer foam with the molecular sieve material may be pack in fine silica sand box as shown in 44. This may allow the silica sand to cover and fill into the cavities formed in the molecular sieve material. Next, an electrode material may be applied to the open cell reticulated polymer foam with the covered molecular sieve material as shown in 46. The electrode material may be applied in different manners. In accordance with one embodiment, molten electrode metal may be poured over the open cell reticulated polymer foam with the covered molecular sieve material. The molten electrode metal may be zinc, lead, iron, copper or similar metals. The heat of the molten electrode metal may vaporize the open cell reticulated polymer foam. This may replace the reticulated cavities in the open cell reticulated polymer foam with metal. After cooling down, the silica sand may be removed while exposing the molecular sieve material on the surface of the metal cover reticulated substrate. Additional electrode metal and be added to the surface of the molecular sieve material either by electroplating or cladding. Thus, the cavities formed in as well as the exterior surfaces of the molecular sieve material may be coated with the electrode metal.

Alternatively, the electrode material may be applied in a similar manner as that described in U.S. Pat. No. 10,079,382. The open cell reticulated polymer foam with the covered molecular sieve material may be placed in an ultrasonic tank containing the conductive coating material. The electrode material may be applied in a similar manner as described above with the open cell reticulated polymer foam with the covered molecular sieve material being coated with a first wash and a second wash. Again, these methods may allow the cavities formed in as well as the exterior surfaces of the molecular sieve material to be coated with the electrode metal.

The foregoing description is illustrative of particular embodiments of the application, but is not meant to be a limitation upon the practice thereof. The following claims, including all equivalents thereof, are intended to define the scope of the application.

What is claimed is:

1. A method of forming an electrode in an electrochemical battery comprising:
coating a reticulated substrate with a first wash, the first wash having a conductive material with conductive fibrous members; and
curing the reticulated substrate coated with the first wash having the conductive material with the conductive fibrous members.

2. The method of claim 1, comprising:
applying a second wash to the reticulated substrate, the second wash comprising the first wash and battery cathode materials; and
curing the reticulated substrate coated with the second wash having the conductive material with conductive fibrous members and the battery cathode materials.

3. The method of claim 1, wherein the first wash comprises a molecular sieve material.

4. The method of claim 1, wherein the first wash comprises silica.

5. The method of claim 1, wherein coating the reticulated substrate with a first wash comprises immersing the reticulated substrate in an aqueous solution mixed with the conductive material with conductive fibrous members.

6. The method of claim 1, wherein coating the reticulated substrate with the conductive material comprises:
immersing the reticulated substrate in an ultrasonic tank containing an aqueous solution mixed with the conductive material with conductive fibrous members; and
applying ultrasonic wave to break down a surface tension at the boundary layer of the reticulated substrate to promote adhesion of the conductive material with conductive fibrous members.

7. The method of claim 5, wherein the conductive fibrous members material comprises: carbon nanotubes, carbon fiber powder, and graphite.

8. The method of claim 5, wherein the aqueous solution is one of ethanol, alcohol, water or combinations thereof.

9. The method of claim 1, wherein coating the reticulated substrate with the second wash comprises immersing the reticulated substrate in a second aqueous solution comprising the first wash and battery cathode material.

10. The method of claim 9, wherein the battery cathode material is one of: Manganese-oxide, Lead-oxide, Nickel-oxide and combinations thereof.

11. The method of claim 1, curing the reticulated substrate coated with the first wash comprises heating the reticulated substrate coated with the first wash to a temperature between 200° C. and 500° C.

12. The method of claim 2, wherein curing the reticulated substrate coated with the second wash comprises heating the reticulated substrate coated with the second wash to a temperature between 450° C. and 850° C.

13. The method of claim 3, wherein the molecular sieve material is zeolite.

14. The method of claim 1, wherein the reticulated substrate is one of a reticulated open-cell polymer foam or a reticulated ceramic.

15. The method of claim 1, comprising:
applying an adhesive and molecular sieve material mixture to the reticulated substrate when the reticulated substrate is a reticulated open-cell polymer foam prior to coating the reticulated substrate with a first wash; and
curing the reticulated open-cell polymer foam having the adhesive and molecular sieve material mixture.

16. The method of claim 15, comprising applying a silica sand to the molecular sieve material.

17. A method of forming an electrode in an electrochemical battery comprising:
coating a reticulated ceramic substrate with a first wash, the first wash having a conductive material with conductive fibrous members;
curing the reticulated ceramic substrate coated with the first wash;
applying a second wash to the reticulated ceramic substrate, the second wash comprising the first wash and battery cathode materials;
curing the reticulated ceramic substrate coated with the second wash; and
covering the reticulated ceramic substrate with a molecular sieve.

18. The method of claim 17, wherein coating the reticulated ceramic substrate with the first wash comprises:
immersing the reticulated substrate in an ultrasonic tank containing an aqueous solution mixed with the conductive material with conductive fibrous members, wherein the aqueous solution is one of ethanol, alcohol, water or combinations thereof and wherein the conductive fibrous members material comprises: carbon nanotubes, carbon fiber powder, and graphite; and
applying ultrasonic wave to break down a surface tension at the boundary layer of the reticulated substrate to promote adhesion of the conductive material with conductive fibrous members material.

19. The method of claim 17, wherein coating the reticulated substrate with the second wash comprises immersing the reticulated substrate in a second aqueous solution comprising the first wash and battery cathode material, wherein the battery cathode material is one of: Manganese-oxide, Lead-oxide, Nickel-oxide and combinations thereof.

20. A method of forming an electrode in an electrochemical battery comprising:
applying an adhesive and molecular sieve material mixture to a reticulated open-cell polymer foam;
curing the reticulated open-cell polymer foam having the adhesive and molecular sieve material mixture;
applying a silica sand to the molecular sieve material; and
applying an electrode metal to the reticulated open-cell polymer foam.

21. The method of claim 20, comprising:
removing the silica sand; and
adding additional electrode metal to areas on the molecular sieve material where the silica sand is removed.

22. The method of claim 20, wherein applying an electrode metal to the reticulated open-cell polymer foam comprises applying a molten electrode material to the reticulated open-cell polymer foam.
